(19) United States
(12) Patent Application Publication
(10) Pub. No.: US 2008/0247156 A1
(43) Pub. Date: Oct. 9, 2008

(54) Illumination apparatus

(76) Inventor: Annmarie C. McCants, San Clemente, CA (US)

Correspondence Address: Rodney K. Worrel;WORREL & WORREL, St. Croix Professional Center, 2109 W. Bullard Avenue, Suite 121, Fresno, CA, 93711-1258, US

(21) Appl. No.: 11/784,014

(22) Filed: Apr. 4, 2007

(51) Int. Cl. F21L 4/00

(52) U.S. Cl. 362/157

(57) ABSTRACT

An illumination apparatus having a housing containing a source of electrical energy fully contained therewithin; an illumination assembly operably connected to the source of electrical energy and deployed so as to afford illumination when energized from the source of electrical energy; and a bulb surrounding the illumination assembly and being sufficiently transparent to permit illumination to pass therethrough and beyond.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to an illumination apparatus and, more particularly, to such an apparatus which has the capability of providing illumination, or the like, in environments in which it is difficult, impossible, or otherwise undesirable, for a multiplicity of reasons, to employ conventional devices.

(2) Description of the Prior Art

Since the invention of incandescent lighting, a host of applications of the invention have been developed. One of the primary uses, of course, is general interior and exterior lighting providing illumination sufficient for the objective to be achieved. In most conventional uses, interior or exterior illumination is required or desirable to brighten the surrounding area so as to permit clear, unobstructed vision.

In other instances, lighting may be desired for both these reasons as well as for aesthetic purposes. For example, interior lighting for the home includes various types and styles of lamps and other lighting fixtures. It is, of course, common to wire for electric power homes, businesses, other types of buildings and installations at the time of construction. This is done in accordance with a predefined plan to provide sources of electrical energy for use throughout the structures in various locations through electrical outlets. Electrical appliances, lighting fixtures and the like are typically connected to the electrical outlets through the use of electrical cables, or cords, having electrical plugs at the terminal ends thereof for individual connection to the electrical outlets as convenient. Normally, the electrical cables are connected to the electrical outlet nearest its respective electrical fixture. This may be satisfactory in some circumstances.

However, there are many instances in which use of an available electrical outlet is not satisfactory for the situation involved. For example, with the passage of time circumstances may develop in which it may be desirable to have an electrical outlet at a location other than was originally provided. There may be obstructions such as walls, furniture, or the like, which make connection to the nearest electrical outlet inconvenient or impossible. While rewiring the structure to provide such an electrical outlet, or outlets, may be possible, this is inconvenient, time consuming and may be expensive.

Furthermore, surfaces such as carpeting, flooring and other installations may require that the electrical cable be extended thereacross creating a hazard to people passing thereover. In other cases the electrical cable may be extended beneath carpeting, or the like, to conceal the electrical cable from view and reduce the foregoing hazard and others. However, this also creates a hazardous condition due, for example, to wearing of the electrical cable from passage of people and other objects thereacross. A fire hazard, as well as other hazards, may thereby be created.

In other circumstances, there may be electrical fixtures, or the like, which are desired to be stationed, or positioned, where it is aesthetically undesirable to have an electrical outlet and/or electrical cable which is visible. Such electrical sources are considered to be unsightly and a detraction from an otherwise appealing ambiance. Illustrative examples of such fixtures are table lamps, lights in exposed areas such as on a mantle over a fireplace, overhead lighting, lighting on counters, desk tops, kitchen and bathroom surfaces and many more. Such conventional installations may create still other hazards such as electrical shock, particularly where water is in proximity thereto.

Still further, there are many environments in which electrical outlets are not available, not conveniently useable, or otherwise not practical for usage. Such is the case, for example, in automotive vehicles, boats, aircraft, and activities such as camping and the like. In such environments, conventional fixtures are inadequate, unsafe, or impossible to use. Such conventional products include flashlights, lanterns, gas lighting, flares, glow sticks, campfires and many other conventional products and practices.

Therefore, it has long been recognized that it would be desirable to have an illumination apparatus which can dependably be used as a light source; which can be operated for a lengthy period of time; which can be operated in a wide variety of environments including, but not limited to, metropolitan as well as remote locations; which is fully operable entirely independent of any supporting system, material, fixture, or the like; which can be employed for interior as well as exterior lighting; which produces illumination sufficient for virtually all uses; which eliminates the hazards associated with conventional products and systems; and which is otherwise entirely effective in accomplishing its intended objectives.

### BRIEF SUMMARY OF THE INVENTION

Therefore, it is an object of the present invention to provide an improved illumination apparatus.

Another object is to provide such an apparatus which can dependably be employed as a light source.

Another object is to provide such an apparatus which is entirely self-contained so as to be fully operable entirely independent of any supporting system, equipment, or other product.

Another object is to provide such an apparatus which can be employed to provide both interior and exterior lighting.

Another object is to provide such an apparatus which is operable in virtually any environment including, but not limited to, metropolitan as well as remote locations.

Another object is to provide such an apparatus which can be employed to take into account aesthetic considerations in virtually all circumstances.

Another object is to provide such an apparatus which avoids the necessity of using electrical cables, electrical outlets and the like in order to operate thereby achieving aesthetic benefits without sacrificing the quality of illumination or multiplicity of applications.

Another object is to provide such an apparatus which entirely avoids the hazards associated with conventional products.

Another object is to provide such an apparatus which possesses a long operational life before requiring attention thereto.

Another object is to provide such an apparatus which simulates the appearance of a conventional light source while avoiding the deficiencies thereof.

Further objects and advantages are to provide improved elements and arrangements thereof in an apparatus for the purpose described which is dependable, economical, durable and fully effective in accomplishing its intended purposes.

These and other objects and advantages are achieved, in the preferred embodiment of the present invention, in an illumination apparatus having a housing containing a source of electrical energy fully contained therewithin; an illumination assembly operably connected to the source of electrical energy and deployed so as to afford illumination when energized from the source of electrical energy; and a bulb surrounding the illumination assembly and being sufficiently transparent to permit the illumination to pass therethrough and beyond.

### BRIEF DESCRIPTION OF THE SEVERAL VIEWS OF THE DRAWINGS

FIG. 1 is a perspective view of one side of the illumination apparatus of the present invention.

FIG. 2 is a perspective view of a second side of the illumination apparatus.

FIG. 3 is an exploded perspective view of the illumination apparatus.

FIG. 4 is a longitudinal section of the illumination apparatus taken on line 4-4 in FIG. 1.

### DETAILED DESCRIPTION OF THE INVENTION

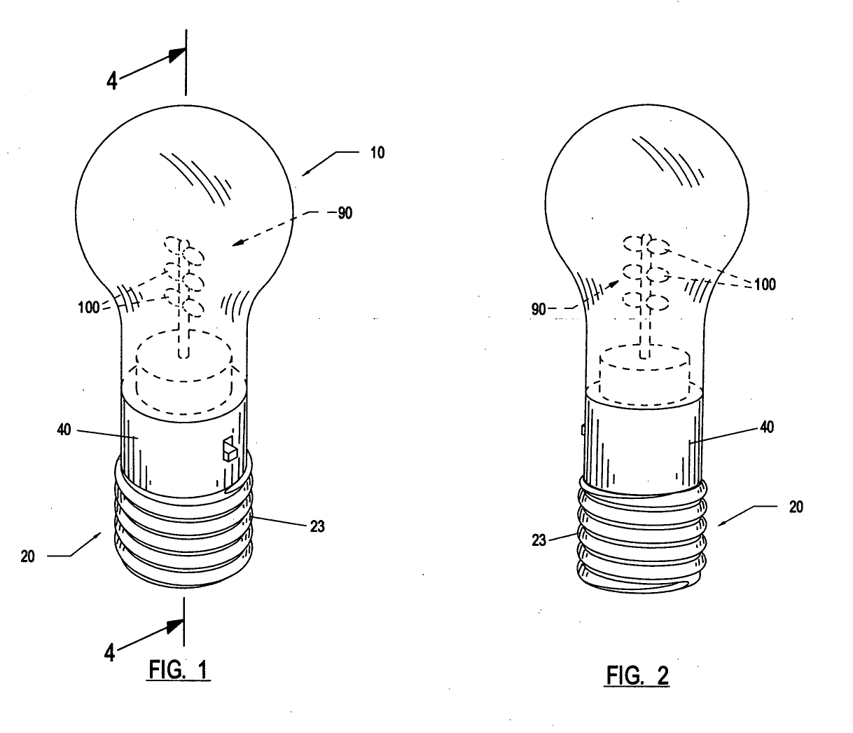

Referring more particularly to the drawings, the illumination apparatus of the present invention in generally indicated by the numeral 10 in FIG. 1.

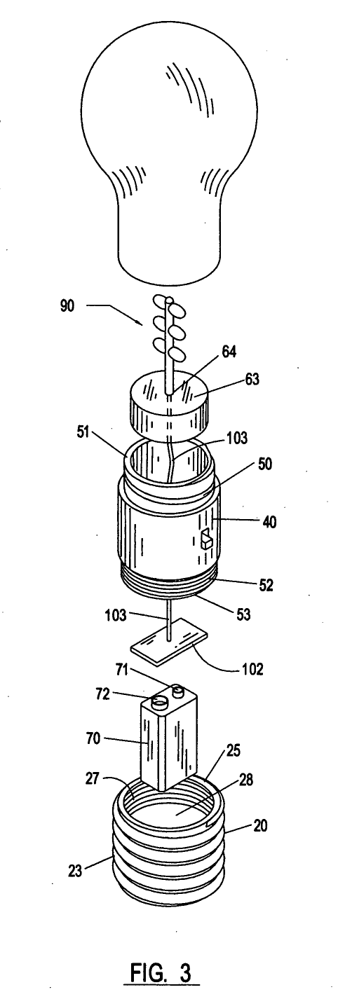

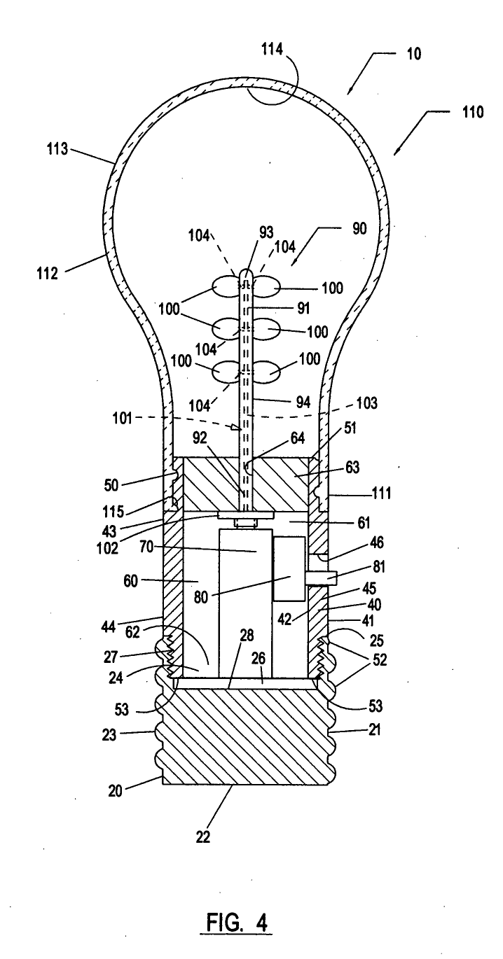

The illumination apparatus 10 is shown in its fully assembled configuration in FIGS. 1, 2 and 4 and a disassembled configuration in FIG. 3. FIG. 4 shows the illumination apparatus in longitudinal section taken on line 4-4 in FIG. 1 in its assembled configuration.

The illumination apparatus 10 has a base member 20 which can be made of any suitable material, but in the preferred embodiment is made of a durable plastic material. The base member has an exterior surface 21 and a bottom surface 22. The exterior surface of the base member has exterior male screw threads 23 extending thereabout. The male screw threads are of a size and pitch adapted to be screw-threadably received in the conventional light socket of a light fixture such as a lamp light fixture or the like, not shown. The base member 20 is of a length such that when the base member is screw-threadably received in a conventional light socket, the bottom surface does not reach the portion of the light socket which normally contacts the surface of the light bulb in electrically transferring relation to the electrically transferring surface of the conventional light socket, as will hereinafter be discussed in greater detail. Thus, electrically transferring relation does not exist between the illumination apparatus 10 and the light socket of the light fixture.

The base member 20 has an upper socket 24 extending to an upper annulus 25. The upper socket 24 is hounded by an interior surface 26 having female screw threads 27 extending therefrom circumferentially about the upper socket, as shown in FIGS. 3 and 4. The upper socket 24 has a bottom wall 28.

The illumination apparatus 10 has a central housing 40 having a cylindrical exterior surface 41 and a cylindrical interior surface 42. The central housing has an upper end portion 43 and an opposite lower end portion 44. The central housing thus has a housing wall 45. A switch opening 46 extends through the housing wall 45, as shown best in FIG. 4.

The upper end portion 43 of the central housing 40 is circumscribed by upper female screw threads 50 which are preferably of a length and pitch suitable for the attachment of a twist off element hereinafter to be described. Alternatively, the upper male screw threads can be of the normal length and pitch such as the female screw threads 27. The upper male screw threads extend to an upper annulus 51. The lower end portion 44 is circumscribed by lower male screw threads 52 of the same length and pitch as the female screw threads 27 of the base member 20. The lower male screw threads 52 of the lower end portion 44 extends to a lower annulus 53.

The central housing 40 is mounted on the base member 20 by screw threaded engagement of the lower male screw threads 52 of the central housing with the female screw threads 27 of the base member, as best shown in FIG. 4.

The housing wall 45 bounds a central compartment 60 having an upper end portion 61 and an opposite lower end portion 62. An end wall 63 is mounted in fixed relation within the interior surface 42 of the upper end portion 43 of the central housing 40. The end wall has a central passage 64 extending axially therethrough.

A battery 70 is mounted within the central compartment 60 by any suitable means. The battery has a positive electrical terminal 71 and a negative electrical terminal 72. The battery can be of any suitable type. As shown in the drawings, the battery is of the nine (9) volt type.

A control switch assembly 80 is mounted within the central compartment 60 by any suitable mount. An “on/off” switch member 81 is operably mounted on and extended from the switch assembly. The switch member extends through the switch opening 46 of the housing wall 45 a sufficient distance to be operable from the exterior of the central housing 40. Pushing downwardly on the switch member 81, as viewed in FIG. 4, causes the switch member to be placed in the “on” condition. Conversely, pushing upwardly on the switch member, as viewed in FIG. 4, causes the switch to be placed in the “off” condition.

A light source or assembly 90 is mounted on and extends from the end wall 63 of the central housing 40, as shown best in FIG. 4. The light assembly 90 has a mounting mast 91 having a lower end portion 92 and an opposite upper end portion 93. The lower end portion 92 is mounted in the central passage 64 of the end wall 63. The mounting mast has an outer surface 94 extending the entire length thereof.

A plurality of light sources or light-emitting diodes (LED) 100 are operably mounted on and extend from the mounting mast 91. An electrical circuit 101 interconnects the light-emitting diodes with the battery 70 through the control switch assembly 80. The battery is releasably connected to the electrical circuit by a battery attachment assembly 102 which clips onto the positive and negative electrical terminals 71 and 72 respectively. An electrical cable 103 extends from the battery attachment pad assembly 102 upwardly through the mounting mast 91 and is individually operably connected by diode connectors to the respective light-emitting diodes 100.

It will be understood that the light-emitting diodes 100 are activated by operation of the control switch assembly 80. When the switch member 81 is in the “on” condition, the light-emitting diodes are energized and thus emit light. When the switch member is in the “off” condition, the light-emitting diodes are not energized and thus do not emit light. A light-emitting diode (LED) is a small electronic device made from semiconductor materials. A light-emitting diode (LED) emits light when current flows through it.

The illumination apparatus 10 has a bulb assembly generally indicated by the numeral 110. The bulb assembly has a lower end portion 111 and a bulb portion 112. The bulb assembly has an outer surface 113 and an inner surface 114. The inner surface of the lower end portion has male screw threads 115 therewithin. It will be understood that the male screw threads 115 screw-threadably engage the upper female screw threads 50 of the central housing 40 thereby mounting the bulb assembly 110 on the central housing 40. The bulb assembly preferably, but not necessarily, consists of a heat resistant, hard, clear plastic. The bulb assembly can be clear as described and shown herein or can be frosted, of a given color, or any other type. Similarly, the bulb assembly can be of any size or shape desired.

### Operation

The operation of the described embodiment of the subject invention is believed to be clearly apparent and is briefly summarized at this point.

The illumination apparatus 10 can be manufactured in a wide variety of different forms. While the illumination apparatus is herein shown and described in its preferred embodiment, it can be manufactured in larger or smaller sizes; and with larger or smaller or differently shaped base members and/or bulb assemblies 110. The bulb assemblies can be fully transparent, or frosted, or of any color, or as otherwise desired. The bulb assembly as shown and described herein is, for illustrative convenience, fully transparent, or clear. In this form it releases a greater amount of light than in other forms.

The illumination apparatus 10 is, in normal use, releasably mounted in the light socket of a lamp or other light fixture, not shown. This is accomplished by screw threadably mounting the base member 20 in the light socket using the exterior male screw threads 23 thereof. The bottom surface 22 of the base member is foreshortened, as compared with a conventional light bulb, so as not to be engageable with the electrically transmitting surface of the light socket.

When it is desired to activate the illumination apparatus 10, the on/off switch member 81 of the control switch assembly 80 is moved to the “on” position. This action causes electrical energy to pass along the electrical circuit 101 thereof from the battery 70, through the electrical cable 103 into the mounting mast 91 of the light assembly 90 and individually to the light-emitting diodes 100 through the diode connectors 104. The light-emitting diodes are thus energized to emit light. Collectively, the light-emitting diodes thereby generate sufficient light to provide the desired illumination. This illumination passes through and from the transparent bulb portion 112 of the bulb assembly 110 to the surrounding area desired to be lighted.

It will be understood that a greater or lesser number of light-emitting diodes 100 can be employed in accordance with the amount of light desired. Similarly, light-emitting diodes of any desired intensity, or amount of light generated, can be employed. If desired, light-emitting diodes of different intensity can be employed in any desired combination. A battery 70 of the necessary power capability can be employed in accordance with the requirements of the number of light-emitting diodes employed and the electrical power required to energize them to emit light. The battery attachment pad assembly 102 is releasably connected to the positive and negative electrical terminals 71 and 72 to permit replacement of the battery when necessary.

The illumination apparatus 10 thus can be employed in virtually any light fixture without electrical energy from an external source being supplied to the apparatus. All of the electrical energy required is supplied by the battery 70 within the illumination apparatus.

When it is necessary to replace the battery 70, the base member 20 is removed from the central housing 40 by screw threadably removing the base member from the female screw threads 27 thereby accessing the control compartment 60. The battery to be removed is removed from the battery attachment pad assembly and replaced with a fresh battery.

Therefore, the illumination apparatus provides a device which can dependably be used as a light source; which makes possible the use of a light fixture, lamp, or the like at any location independent of any other source of electrical energy; which can be operated for a lengthy period of time; which can be operated in a wide variety of environments including, but not limited to, household, metropolitan and remote locations; which is fully operable entirely independent of any supporting electrical system, material, fixture, or the like; which can be employed for interior as well as exterior lighting; which produces illumination sufficient for virtually all uses; which eliminates the hazards associated with conventional products and systems; and which is otherwise entirely effective in accomplishing its intended objectives.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. An illumination apparatus comprising a housing; a source of energy contained within the housing; an illumination assembly mounted on the housing in operable connection with said source of energy and deployed so as to afford illumination when energized from the source of energy; and means for selectively energizing said source of energy selectively to afford said illumination from the illumination assembly.

2. The illumination apparatus of claim 1 including a substantially transparent enclosure mounted on the housing in covering relation to said illumination assembly to permit the illumination created thereby to pass through the enclosure into the surrounding area.

3. The illumination apparatus of claim 2 wherein said enclosure is shaped to simulate a light bulb.

4. The illumination apparatus of claim 2 wherein said enclosure is of a substantially transparent plastic material permitting the passage of illumination therethrough and into said surrounding area.

5. The illumination apparatus of claim 4 wherein the housing has a lower end portion so configured as to be capable of being releasably mounted in a light socket of a light fixture so as to simulate a conventional light.

6. The illumination apparatus of claim 5 wherein said lower portion has a foreshortened lower surface so as to be spaced from an electrical transferring surface of said light socket so as not to receive electrical energy therefrom.

7. The illumination apparatus of claim 6 wherein said source of energy is a battery operable to provide electrical energy to said illumination assembly.

8. The illumination apparatus of claim 7 wherein said illumination assembly includes at least one light-emitting diode mounted in electrical receiving relation from said battery.

9. The illumination apparatus of claim 8 wherein the battery is operable to provide direct electrical current.

10. The illumination apparatus of claim 9 wherein a control switch is mounted on said housing so as to be selectively operable from externally of the housing to place said battery in an on position in electrically transferring relation to said light-emitting diode and, alternatively, in an off position in non-electrically transferring relation to said light-emitting diode.

11. The illumination apparatus of claim 10 wherein a plurality of light-emitting diodes are mounted on a mast in electrical receiving relation from said battery.

12. The illumination apparatus of claim 11 wherein the housing has an internal chamber in which said battery is releasably mounted and the lower end portion of said housing is selectively removable from the housing to gain access to said internal chamber for replacement of said battery.

13. The illumination apparatus of claim 12 wherein said enclosure is releasably mounted on the housing to gain access the light-emitting diodes for replacement of one or more of said light-emitting diodes.

14. The illumination apparatus of claim 13 wherein said lower end portion of the housing has screw threads thereabout to enable said housing selectively to be removably mounted in a light socket.
